(19) United States
(12) Patent Application Publication
(10) Pub. No.: US 2001/0022705 A1
(43) Pub. Date: Sep. 20, 2001

(54) Glass substrate for recording medium

(76) Inventors: Toshiharu Mori, Osaka (JP); Hideki Kawai, Nishinomiya-Shi (JP); Akira Sugimoto, Nishinomiya-Shi (JP); Hiroshi Yuki, Shiga-Ken (JP); Hideki Nagata, Kobe-Shi (JP); Kazuhiko Ishimaru, Kaizuka-Shi (JP)

Correspondence Address: Platon N. Mandros, Esq., BURNS, DOANE, SWECKER & MATHIS, L.L.P., P.O. Box 1404, Alexandria, VA, 22313-1404, US

(21) Appl. No.: 09/808,020

(22) Filed: Mar. 15, 2001

(30) Foreign Application Priority Data
Mar. 16, 2000 (JP) 00-0079343

(51) Int. Cl. B32B 3/02; G11B 5/82; C03C 10/08; C03C 10/10; C03C 10/12; C03B 11/00; C03B 25/00; C03B 32/02; C03C 3/085

(52) U.S. Cl. 360/135; 65/66; 65/33.4; 65/61; 65/33.7; 428/64.3; 428/65.3; 428/64.4; 501/68; 501/69; 65/33.8

(57) ABSTRACT

A polished glass disk medium substrate table for use as a substrate for a hard disk, a hard disk containing the substrate and methods for making the substrate. Glass forming raw materials are formed into a disk having a diameter between about 70 mm and about mm, a thickness between about 0.7 mm and about 0.9 mm, a flutter of less than 90 nm at 10,000 rpm.

### RELATED APPLICATION

This application claims priority to Japanese Patent Application No. H2000-79343 filed in Japan on Mar. 16, 2000, the contents of which are hereby incorporated by reference.

### FIELD OF THE INVENTION

The present invention relates to a glass substrate, and more specifically relates to a crystallized glass substrate for a disk medium such as a hard disk, optical recording medium, magnetic recording medium, magnetic-optical recording medium or the like.

### DESCRIPTION OF THE RELATED ART

Aluminum and glass substrates have been used for disk media such as a hard disk and the like. Glass substrates have received the most attention due to their superior surface smoothness and mechanical strength. Such glass substrates include chemically reinforced glass substrates wherein the substrate surface is reinforced by ion exchange, crystallized glass substrates wherein bonds are strengthened by depositing a crystal component on the glass substrate and the like.

Hard disk devices achieve a high recording density by providing an extremely small space between the hard disk medium and a magnetic head which floats via a dynamic pressure bearing above the hard disk medium. Accordingly, glass substrates used as disk media have high production while maintaining exceptional surface smoothness.

When a conventional glass substrate is used as a disk medium, however, the magnetic head is quite susceptible to impact against the recording medium due to the small spacing provided between the hard disk medium and the magnetic head. On the other hand, if a larger space is employed, high density recording cannot be achieved.

### SUMMARY OF THE INVENTION

An object of the present invention is to provide an improved glass substrate.

Another object of the present invention is to provide a glass substrate capable of high density recording which allows minimizing the spacing between the hard disk medium and the magnetic head.

These objects are attained by one aspect of the present invention which provides a glass substrate for use as a hard disk having a preferred diameter of about 70 mm or more but less than about 90 mm, and a preferred thickness of about 0.7 mm or more but less than about 0.9 mm, and a preferred flutter of less than about 90 nm at 10,000 rpm.

When a 3-inch hard disk made of a glass substrate having a thickness of about 0.7 to about 0.9 mm is rotated at 10,000 rpm, flutter is desirably less than 90 nm. Flutter is measured by determining the amount of vibration of the exterior surface in the axial direction using a laser vibrometer.

In a preferred embodiment, the glass substrate has a flutter of about 58 nm or more at 10,000 rpm.

In another preferred embodiment, the glass substrate has a Log η of about 1.5 or higher at 1400° C. when the viscosity of the substrate is η poise. It is even more desirable that the glass substrate has a Log η of about 2.5 or higher under these same conditions.

In another preferred embodiment, the glass substrate has a Log η of about 2.0 or higher at 1300° C. when the viscosity of the substrate is η poise. It is even more desirable that the glass substrate has a Log η of about 3.0 or higher under there same conditions.

In another preferred embodiment, the glass substrate has a Log θ of about 2.4 or higher at 1200° C. when the viscosity of the substrate is η poise. It is even more desirable that the glass substrate has a Log η of about 3.5 or higher under these same conditions.

In another preferred embodiment, the glass substrate has an internal friction coefficient of about 8×10⁻⁴ to about 16×10⁻⁴. In this embodiment, it is desirable for the proportion of dynamic energy loss due to natural vibration per one-cycle added to the suspended disk media glass substrate to be about 8×10⁻⁴ to about 16×10⁻⁴.

In yet another preferred embodiment, the damping coefficient is about 5×10⁻⁴ to about 12×10⁻⁴. According to this embodiment, the loss coefficient due to attenuation of natural vibration generated by impact on the suspended hard disk media glass substrate is desirably about 5×10⁻⁴ to about 12×10⁻⁴.

In yet another preferred embodiment, the glass substrate has a specific gravity less than about 3.

The glass substrate according to preferred embodiments may be prepared by heating the raw materials to about 730 to about 770° C., maintaining the temperature for about 2 to about 7 hrs, elevating the temperature to about 820 to about 900° C., and maintaining the temperature for about 3 to about 7 hrs.

The composition range of the raw materials used to prepare a preferred glass substrate according to the present invention are provided below:

about 45 wt % or more but less than about 60 wt % SiO₂;

about 12 wt % or more but less than about 20 wt % Al₂O₃;

about 0.1 wt % or more but less than about 4 wt % Li₂O;

about 12 wt % or more but less than about 20 wt % MgO;

about 2 wt % or more but less than about 60 wt % TiO₂;

about 0.1 wt % or more but less than about 5 wt % P₂O₅.

These and other objects and features of this invention will become clear from the following description taken in conjunction with the preferred embodiments with reference to the accompanying drawings.

### BRIEF DESCRIPTION OF THE DRAWINGS

FIG. 1 is a flow chart of a manufacturing process of an embodiment of the hard disk media glass substrate;

FIG. 2 is a temperature chart of the heating steps performed in the of a manufacturing process;

FIG. 3 illustrates a method used to measure the internal friction coefficient of a disk media glass substrate of the present invention;

FIG. 4 is a resonance curve;

FIG. 5 illustrates a method of measuring the damping coefficient of a disk media glass substrate of the present invention;

FIG. 6 illustrates a method of measuring the flutter characteristics of a disk media glass substrate of the present invention;

FIG. 7 provides the flutter characteristics of an embodiment of the present invention;

FIG. 8 provides the composition ratios and physical properties of embodiments of the present invention;

FIGS. 9-11 provides the damping and internal friction coefficients of embodiments of the present invention;

FIG. 12 provides a graph illustrating viscosity versus temperature;

FIG. 13 provides the flutter characteristics of an embodiment of the present invention;

FIG. 14 illustrates an embodiment of a substrate of the present invention; and

FIG. 15 illustrates an embodiment of a hard disk of the present invention.

### DESCRIPTION OF THE PREFERRED EMBODIMENTS

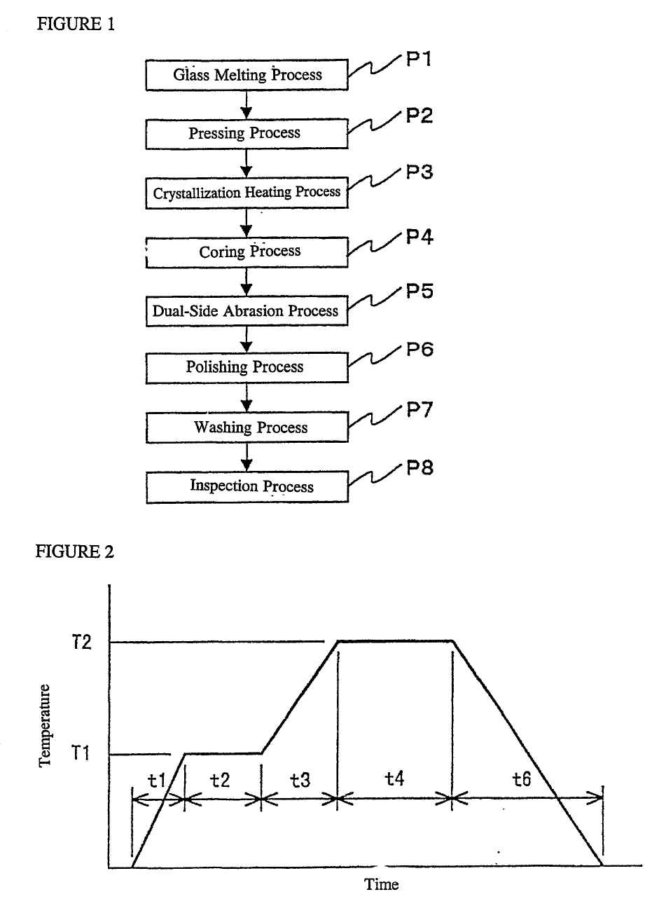

The embodiments of the present invention are described hereinafter with reference to the accompanying figures. FIG. 1 shows the manufacturing process of an embodiment of the disk media glass substrate of the present invention.

First, in the glass melting process, P1, specific glass materials are introduced into a crucible and melted to form a blank. In the pressing process, P2, the molten glass fluid is dripped onto a metal mold of specific shape, and pressure is applied at a specific temperature so as to form a desired shape.

In the crystallization heating process, P3, the blank is arranged within a thermo-regulated bath, and a heating process is performed to induce crystallization. In the coring process, P4, a hole is formed in the center of the circular shaped blank for mounting on a motor or the like. In the dual-side abrasion process, P5, both sides of the blank are ground by a diamond grindstone to rough finish both surfaces of the blank in parallel.

In the dual-side polishing process, P6, both surfaces of the blank are polished using alumina powder or the like, to bring the degree of parallel, degree of flatness, and surface roughness to a predetermined standard value. Then, in the washing process, P7, the polishing powder is removed by washing, and the disk media glass substrate is completed after performing the inspection process, P8.

In the crystallization heating process, P3, the glass substrate is desirably heated based on the temperature chart shown in FIG. 2. In FIG. 2, the vertical axis shows the temperature, and the horizontal axis shows the time. When the heating process starts, the temperature of the blank is gradually increased during a temperature elevation time t1 until a primary temperature T1 is attained at which a crystal nucleus is formed.

When the blank attains the primary temperature T1, the blank is maintained at the primary temperature T1 for a primary time t2, and the crystal nuclei are formed. When the primary time t2 has elapsed and the crystal nuclei have formed, the temperature of the blank is gradually increased during a temperature elevation time t3 until a secondary temperature T2 is attained at which temperature the crystals grow. When the blank has attained the secondary temperature T2, the blank is maintained at the secondary temperature T2 for a secondary time t4 to grow the crystals. When the secondary time t4 has elapsed and the crystals have grown to a specific size, the blank is annealed and cooled to room temperature gradually during a cooling time t6.

In the crystallization heating process of the present embodiment, the following conditions were employed:

Primary temperature T1: about 730 to about 770° C.;

Primary time t2: about 2 to about 7 hrs;

Secondary temperature T2: about 820 to about 900° C.;

Secondary time t4: about 3 to about 7 hrs.

The characteristics described below are obtained by preparing a disk media glass substrate wherein the composition range of the main constituents in the above manufacturing process are as follows:

about 45 wt % or more but less than about 60 wt % Si0₂;

about 12 wt % or more but less than about 20 wt % Al₂O₃;

about 0.1 wt % or more but less than about 4 wt % Li₂O;

about 12 wt % or more but less than about 20 wt % MgO;

about 2 wt % or more but less than about 10 wt % TiO₂.

When the SiO₂ composition percentage used as a glass forming oxide is less than about 45 wt %, the melting characteristics are often adversely affected, and when the composition percentage exceeds about 60 wt %, the glass enters a stable state and crystal deposition typically becomes difficult.

Al₂O₃ is an intermediate oxide of glass, and is a structural component of the magnesium alkali crystal in a crystal phase when deposited by the heating process. When the composition percentage is less than about 12 wt %, crystal deposition is reduced and desired strength is difficult to obtain, whereas when the composition percentage exceeds about 20 wt %, the melting temperature is elevated and devitrification readily occurs.

Li₂O functions as a fluxing agent, and improves stability during mass production. When the composition percentage is less than about 0.1 wt %, melting characteristics are often adversely affected, and when the composition percentage exceeds about 4 wt %, stability is often adversely affected during the dual-side polishing process and the washing process.

MgO is a fluxing agent, and adding MgO induces agglomeration of powder-like crystals to form crystal particle nodules. When the composition percentage is less than about 12 wt %, the working temperature range is often narrowed, and the chemical durability of the glass matrix phase is typically not improved. When the composition percentage exceeds about 20 wt %, other crystals are deposited, and the desired strength typically becomes difficult to obtain.

TiO₂ functions as a nucleating agent, and improves stability during mass production. When the composition percentage is less than about 2 wt %, melting characteristics are often adversely affected and crystal growth typically becomes difficult. When the composition percentage exceeds about 10 wt %, crystallization progresses rapidly, control of the crystallization state typically becomes difficult, deposited crystals are large and coarse, and crystal phase heterogeneity often occurs. For these reasons a fine, homogeneous crystal structure is often difficult to obtain, and a desired smoothness is often difficult to obtain in the dual-side polishing process. Furthermore, devitrification readily often occurs during melting formation, and reduces mass production qualities.

It is desirable to add P₂O₅ at a rate of about 0.1 wt % or more but less than about 5 wt % to the composition. P₂O₅ functions as a fluxing agent, and is a nucleus forming agent for depositing silicate crystals, and can uniformly deposit crystals on the entire glass.

When the amount of P₂O₅ is less than about 0.1 wt %, it typically becomes difficult to form sufficient crystal nuclei, crystal particles are large and coarse, and deposited heterogeneously, and a fine uniform crystal structure is typically difficult to obtain. For this reason the desired surface smoothness is often difficult to obtain in the dual-side polishing process for use as a disk media glass substrate.

When the amount of P₂O₅ exceeds about 5 wt %, reactivity to the filter medium is often increased when melting, and devitrification typically becomes severe, such that mass production characteristics are reduced during melting. Chemical durability is also often reduced, and there is concern that the magnetic layer formed on the substrate surface will be affected, and stability is adversely affected during the dual-side polishing process and the washing process.

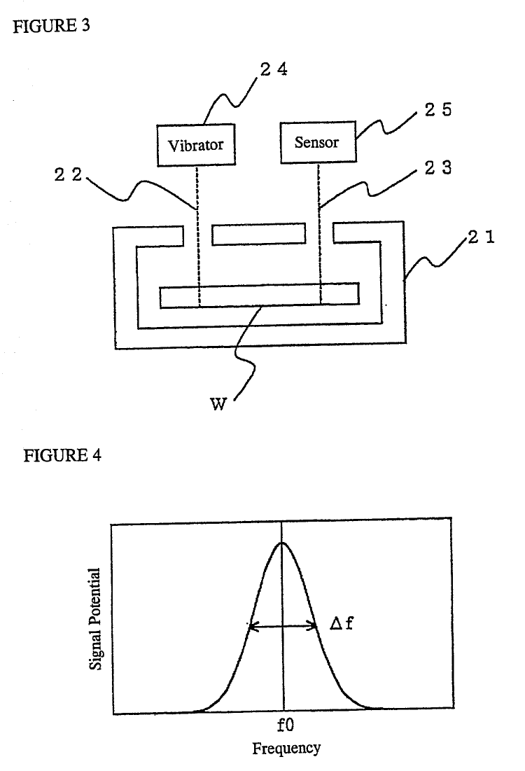

FIG. 3 illustrates the method used to measure the internal friction coefficient of the disk media glass substrate. The measurement principle is dependent on bend resonance; a vibrator 24 imparts a vibration to a specimen W suspended within hood 21 via filament line 22 and 23. Vibration is detected by a sensor 25, and a resonance curve is obtained as shown in FIG. 4. In FIG. 4, the vertical axis shows the signal potential representing the magnitude of the vibration detected by the sensor 25, and the horizontal axis shows the frequency.

The signal potential was maximum at the primary natural frequency f0 at which the specimen W was most readily fluctuated. Since the resonance curve was sharp and the energy scattering was small, the dynamic energy loss due to natural vibration per one-cycle can be expressed by the internal friction coefficient 1/q, such that 1/q=Δf/(3_{½}·f0). Where Δf is the peak width at half height of the resonance curve. The dynamic energy scattering is large when the value of the internal friction coefficient 1/q is large.

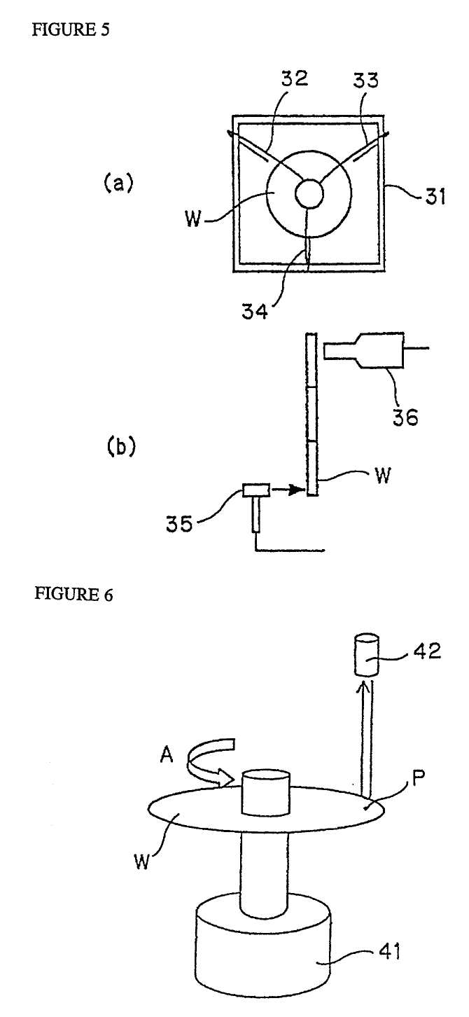

FIG. 5 illustrates the method of measuring the damping coefficient of the disk media glass substrate. FIGS. 5(a) and 5(b) show a front view and a side view, respectively. A specimen W suspended within a hood 31 by filament line 32, 33, 34 is struck with an iso-pulse hammer 35. Sound pressure is detected by a sound level meter, and the vibration loss coefficient (damping coefficient) is measured by the noise attenuation record. When the damping coefficient is large, the vibration attenuates more rapidly.

FIG. 6 illustrates the method of measuring the flutter characteristics of the disk media glass substrate. A specimen W was rotated at high speed in the arrow A direction using an air spindle motor 41, and a laser beam irradiated the surface of the specimen W via a laser vibrometer. The light reflected by the surface of the specimen W changes frequency depending on the vibration in the axial direction of the specimen W, the amount of vibration (flutter) in one-cycle of the specimen W is detectable. A position 1.5 mm from the exterior surface of the specimen W is designated the measurement point P.

The disk media glass substrate of the present embodiment having the previously described composition desirably has the characteristics described below. Viscosity η (poise) is represented by Log η.

Specific gravity: < about 3.0

Viscosity (1400° C.): about 1.5≦Log f1≦ about 2.5

Viscosity (1300° C.): about 2.0≦Log i≦ about 3.0

Viscosity (1200° C.): about 2.4≦Log f1≦ about 3.5

Internal friction coefficient 1/q (×10⁻⁴) : about 8.0 to about 16.0

Damping coefficient (×10⁻⁴) : about 5.0 to about 12.0

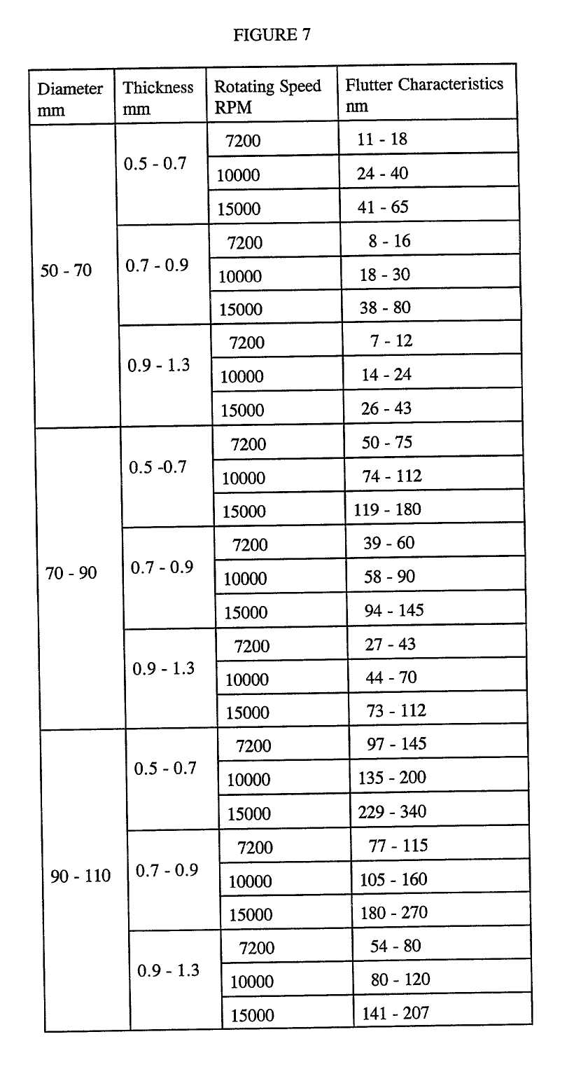

Flutter characteristics are shown in FIG. 7. According to the drawing, flutter characteristics at each RPM setting invariably have a lower value under parameters of diameter and thickness of the disk media glass substrate.

Accordingly, when the disk media glass substrate of the present embodiment is installed in a disk device such as a hard disk, the occurrence of head impact is controllable even when the spacing between the magnetic head and the glass substrate are small, thereby improving reliability of the disk device, and allowing high recording density of the disk device.

When the composition or heating process parameters of the disk media glass substrate are changed in order to reduce flutter characteristics to less than the lower limit value shown in FIG. 7, the glass substrate may not be manufactured stably, and yield may be reduced.

Furthermore, changing the composition and conditions of the heating process to reduce the internal friction coefficient below about 8×10⁻⁴, adversely affects flutter characteristics, and the glass substrate may not be stably manufactured when the friction coefficient is increased beyond about 16×10⁻⁴. Similarly when the damping characteristics are reduced to less than 5×10⁻⁴, flutter characteristics may be adversely affected, and when damping characteristics are increased beyond 12×10⁻⁴, manufacture may be difficult.

Similarly, manufacturing the glass substrate may be difficult when viscosity (Log η) is reduced to less than 1.5 at 1400° C., 2.0 at 1300° C., and 2.4 at 1200° C. Moreover, flutter characteristics may be adversely affected when viscosity exceeds 2.5 at 1400° C., 3.0 at 1300° C., and 3.5 at 1200° C.

Since the disk media glass substrate become heavy and the power consumption of the disk device increases when the specific gravity is greater than 3.0, it is desirable that the specific gravity is reduced to about 3.0 or less via the composition and heating process conditions of the present embodiment.

### EXAMPLES

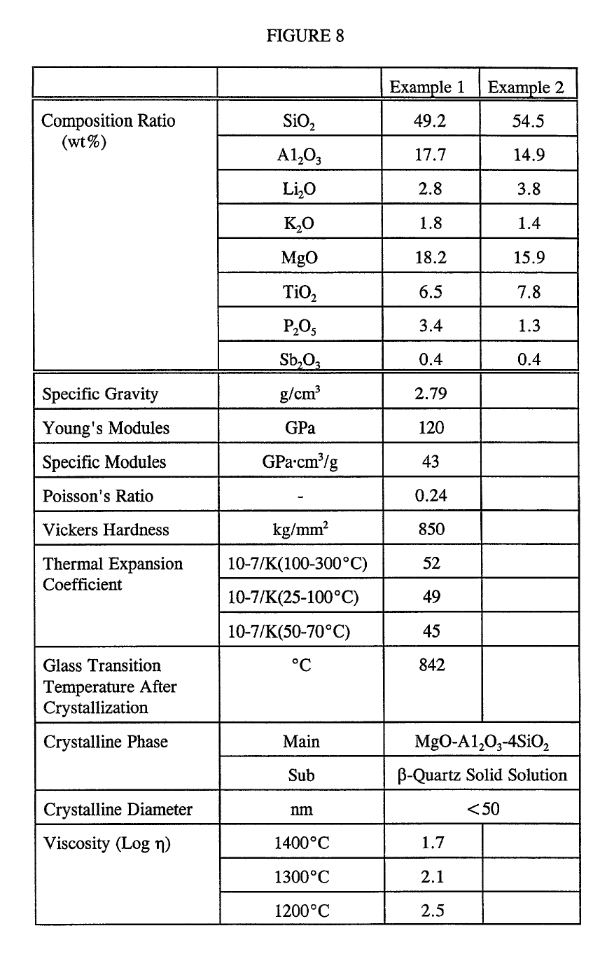

Various examples are described below. The composition ratios of the first and second examples are shown in FIG. 8. The composition ratio of the first example is 49.2 wt % Si0₂, 17.7 wt % Al₂O₃, 2.8 wt % Li₂O, 1.8 wt % Disk₂O, 18.2 wt % MgO, 6.5 wt % TiO₂, 3.4 wt % P₂O₅, and 0.4 wt % Sb₂O₃.

The composition ratio of the second example is 54.5 wt % Si0₂, 14.9 wt % Al₂O₃, 3.8 wt % Li₂O, 1.4 wt % Disk₂O, 15.9 wt % MgO, 7.8 wt % TiO₂, 1.3 wt % P₂O₅, and 0.4 wt % Sb₂O₃.

In all cases, stability during manufacture was improved by adding K₂O as a fluxing agent. When the composition ratio of K₂O was less than about 0.1 wt %, flux characteristics were not adequately improved. When the composition ratio exceeded about 5 wt %, the glass became stable and crystallization was suppressed. Furthermore, chemical durability was reduced, and there was concern of affects to the magnetic layer formed on the surface, and stability was reduced during the dual-side polishing process and washing process.

Stability during mass production was improved by the addition of Sb₂O₃ which functioned as a clarifier. When the composition ratio of Sb₂O₃ was less than about 0.1 wt %, sufficient clarifying effect was not obtained, and production stability was reduced. When the composition ratio exceeded about 5 wt %, glass crystallization became unstable, and the depositing crystal phase became uncontrollable. For these reasons, the desired characteristics could not be obtained.

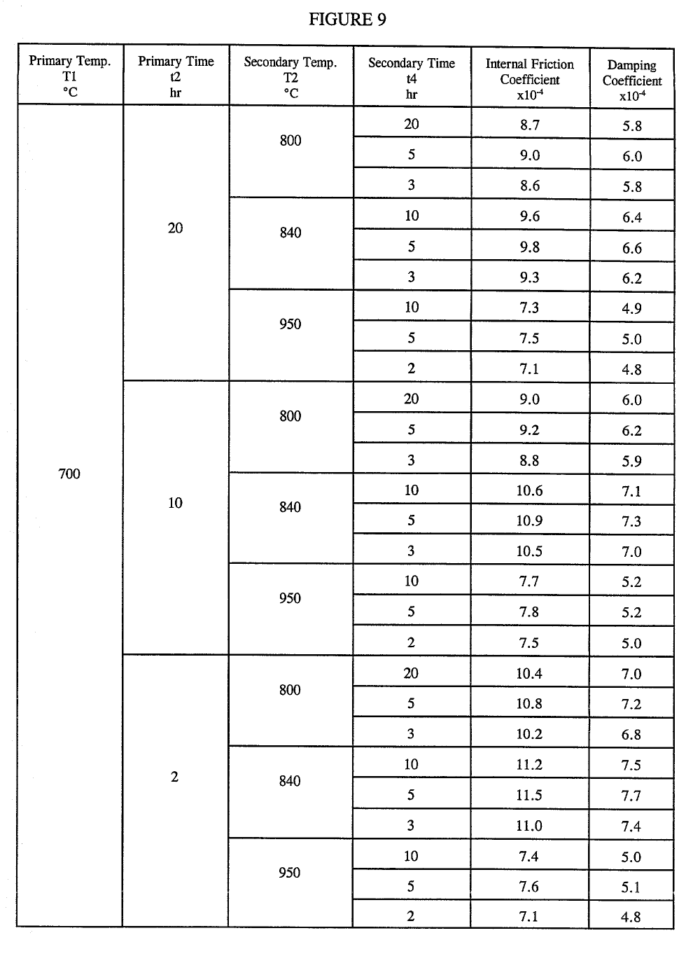

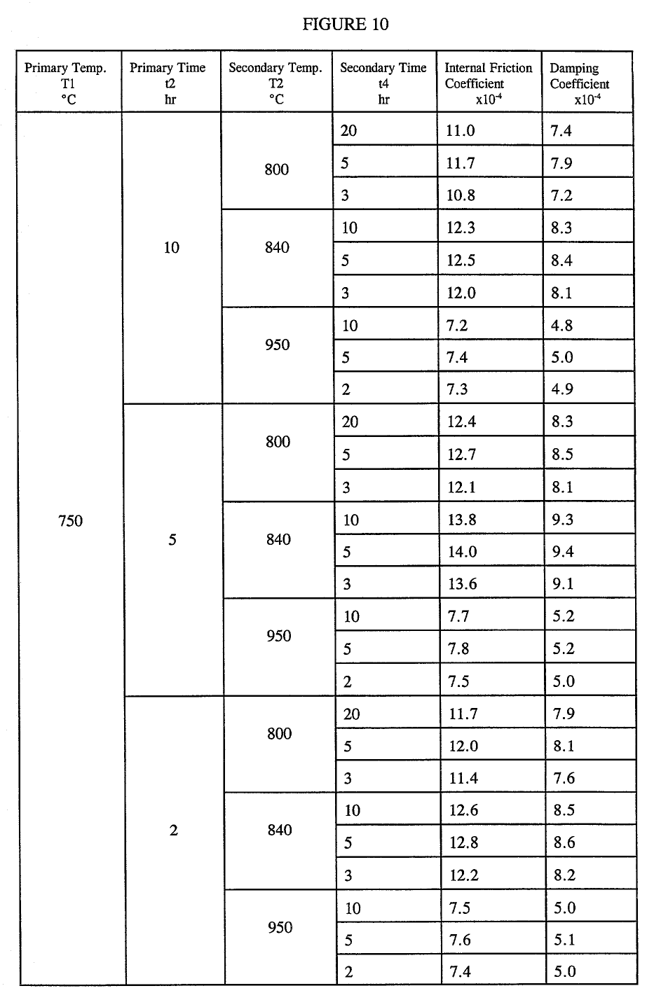

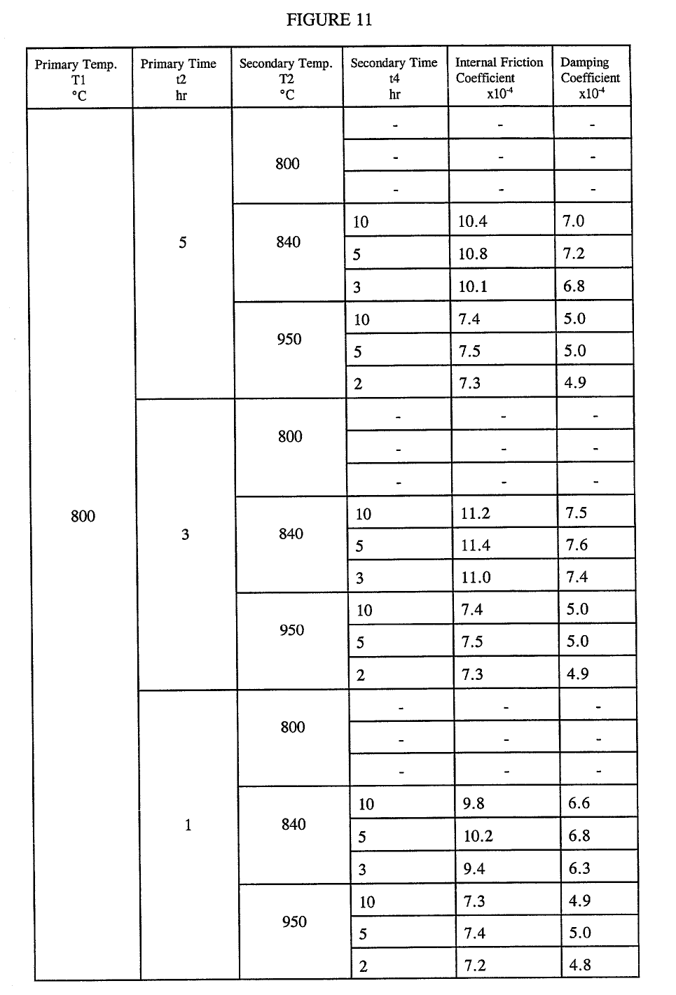

Stable production was attained in both the first and second examples using the heating parameters of the crystallization heating process (refer to FIGS. 1 and 2) described above. FIGS. 9-11 show the results of measuring the damping coefficient and internal friction coefficient of the disk media glass substrate of the first example using the heating process conditions of the crystallization heating process as parameters. FIG. 9 shows the measurement result when the primary temperature T1 was 700° C., FIG. 10 shows the result when the primary temperature T1 was 750° C., and FIG. 11 shows the result when the primary temperature T1 was 800° C.

The results show the highest values of internal friction coefficient and damping coefficient when the primary temperature T1 was 750° C., primary time t2 was 5 hrs, secondary temperature T2 was 840° C., and secondary time t4 was 5 hrs, and these maximum values were 14.0×10⁻⁴ and 4×10⁻⁴, respectively.

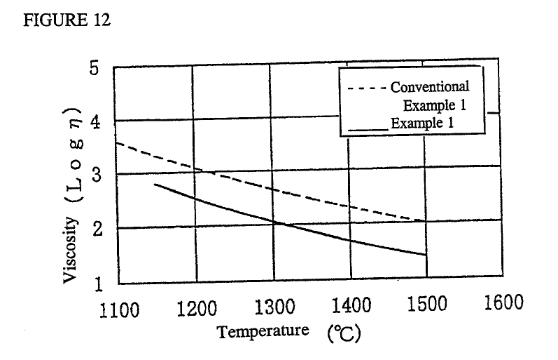

Other physical characteristics at this time are shown in FIG. 8, and the specific gravity was 2.79. Viscosity (Log η) was 1.7 at 1400° C., 2.1 at 1300° C., and 2.5 at 1200° C., which are low compared to the glass substrate of the conventional example as shown in FIG. 12. This shows the flutter characteristics are improved over the conventional example.

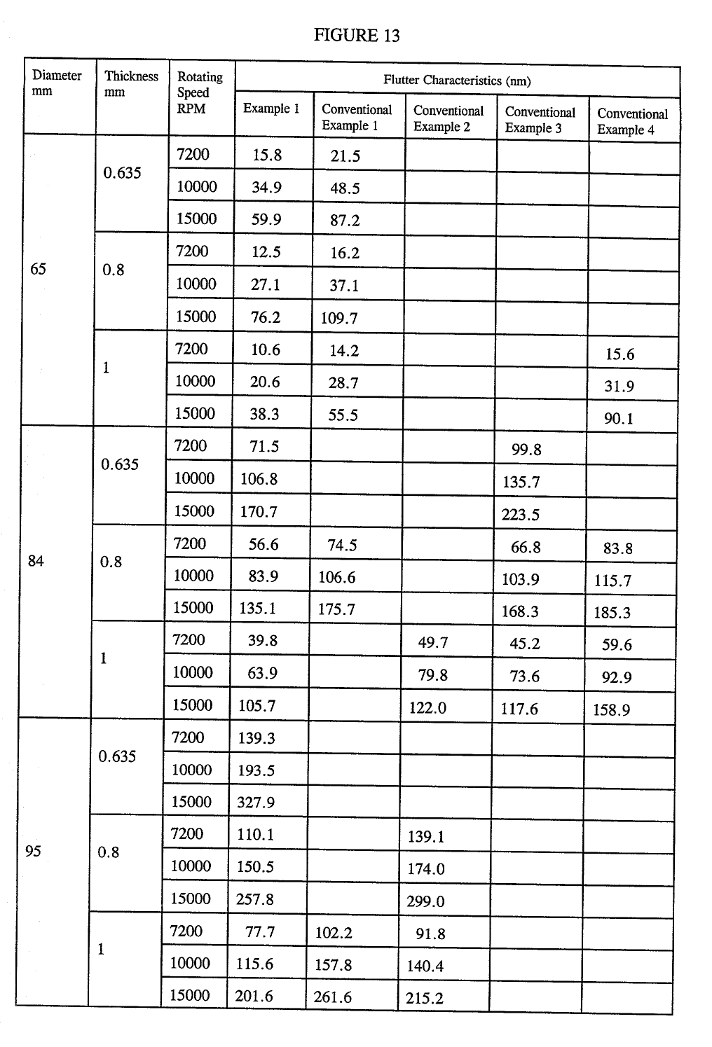

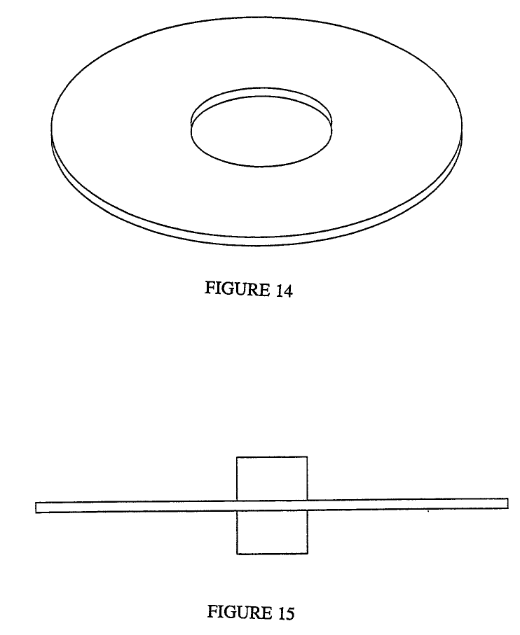

Flutter characteristics are shown in FIG. 13. In the drawing, flutter characteristics of first through fourth conventional examples are given for comparison purposes. The first through third conventional examples are glass substrates, and the fourth conventional example is an aluminum substrate. According to the drawing, flutter characteristics at each rpm are low values compare to the conventional examples using the disk media glass substrate diameter and thickness as parameters.

Flutter characteristics of the second example are also lower than the conventional examples.

According to these examples, when installed in a disk device such as a hard disk, the occurrence of head impact can be suppressed even when the spacing between the glass substrate and the magnetic head is small, thereby improving reliability of the disk device, and allowing high density recording by the disk device.

Although the present invention has been fully described by way of examples with reference to the accompanying drawings, it is to be noted that various changes and modification will be apparent to those skilled in the art. Therefore, unless otherwise noted such changes and modifications do not depart from the scope of the present invention, and they should be construed as being included therein.

What is claimed is:

1. A polished glass disk medium substrate suitable for use as a substrate for a disk medium said disk having a diameter between about 70 mm and about 90 mm, a thickness between about 0.7 mm and about 0.9 mm, and a flutter of less than about 90 nm at 10,000 rpm.

2. The polished glass disk medium substrate according to claim 1, wherein said polished glass disk comprises crystallized glass.

3. The polished glass disk medium substrate according to claim 1, wherein said flutter is less than 58 nm at 10,000 rpm.

4. The polished glass disk medium substrate according to claim 1, wherein said glass has a Log η of 1.5 or higher at 1400° C. when the viscosity of the glass is η poise.

5. The polished glass disk medium substrate according to claim 4, wherein said glass has a Log η of 2.5 or higher at 1400° C. when the viscosity of the glass is η poise.

6. The polished glass disk medium substrate according to claim 1, wherein said glass has a Log η of 2.0 or higher at 1300° C. when the viscosity of the substrate is η poise.

7. The polished glass disk medium substrate according to claim 6, wherein said glass has a Log η of 3.0 or higher at 1300° C. when the viscosity of the substrate is η poise.

8. The polished glass disk medium substrate according to claim 1, wherein said glass has a Log η of 2.4 or higher at 1300° C. when the viscosity of the substrate is η poise.

9. The polished glass disk medium substrate according to claim 8, wherein said glass has a Log η of 3.5 or higher at 1200° C. when the viscosity of the substrate is η poise.

10. The polished glass disk medium substrate according to claim 1, wherein the glass disk medium has an internal friction coefficient of between about 8×10⁻⁴ and about 16×10⁻⁴.

11. The polished glass disk medium substrate according to claim 1, wherein the proportion of dynamic energy loss due to natural vibration per one-cycle added to the suspended disk media glass is between about 8×10⁻⁴ and about 16×10⁴.

12. The polished glass disk medium substrate according to claim 1, wherein the glass disk medium possesses a damping coefficient of between about 5×10⁻⁴ and about 12×10⁻⁴.

13. The polished glass disk medium substrate according to claim 1, wherein the glass disk medium possesses a loss coefficient due to attenuation of natural vibration generated by impact of between about 5×10⁻⁴ and 12×10⁻⁴.

14. The polished glass disk medium substrate according to claim 1, wherein the glass has a specific gravity of less than about 3.

15. The polished glass disk medium substrate according to claim 1, wherein said glass comprises:
ab out 45% to about 60% by weight SiO₂;
about 12% to about 20% by weight Al₂O₃;
about 0.1% to about 4% by weight Li₂O;
about 12% to about 20% by weight MgO;
about 2% to about 60% by weight TiO₂;
optionally about 0.1% to about 5% by weight Disk₂O;
optionally about 0.1% to about 5% by weight P₂O₅; and
optionally about 0.1% to about 5% by weight Sb₂O₃.

16. The polished glass disk medium substrate according to claim 1, wherein said glass is essentially free of BaO, ZnO, ZrO₂, B₂O₃ NiO, and Y.

17. The polished glass disk medium substrate according to claim 1, wherein said K₂O is not optional.

18. The polished glass disk medium substrate according to claim 1, wherein said P₂O₅ is not optional.

19. The polished glass disk medium substrate according to claim 1, wherein said Sb₂O₃ is not optional.

20. The polished glass disk medium substrate according to claim 1, wherein said substrate is prepared by heating glass forming raw materials to a temperature, T₁, between about 730 and 770° C.; maintaining the temperature T₁ for a time between about 2 and about 7 hours; heating the glass forming raw materials to a temperature, T₂, between about 820 and 900° C.; and maintaining the temperature T₂ for a time between about 3 and about 9 hours.

21. A disk medium comprising the polished glass disk medium substrate defined in claim 1.

22. The disk medium according to claim 21, wherein said disk medium is a high density recording disk.

23. The disk medium according to claim 21, wherein said disk medium is a magnetic recording medium.

24. The disk medium according to claim 21, wherein said disk medium is an optical recording medium.

25. The disk medium according to claim 21, wherein said disk medium is a magnetic-optical recording medium.

26. A method of making a glass disk medium substrate comprising:
heating glass forming raw materials to a temperature sufficiently high to melt the raw materials;
forming a disk medium substrate; and crystallizing the disk medium substrate, wherein said crystallizing comprises heating the disk medium substrate to a temperature, T₁, between about 730 and 770° C.; maintaining the temperature T₁ for a time between about 2 and about 7 hours; heating the glass forming raw materials to a temperature, T₂, between about 820 and 900° C.; and maintaining the temperature T₂ for a time between about 3 and about 9 hours.

27. The method according to claim 26, wherein said forming comprises fluid dripping the melted raw materials onto a mold and applying pressure to form a desired shape.

28. The method according to claim 26, wherein said crystallizing occurs in a thermo-regulated bath.

29. The method according to claim 26, further comprising forming a hole in the center of said glass disk medium substrate.

30. The method according to claim 26, further comprising subjecting the glass disk medium substrate to an abrasion process.

31. The method according to claim 30, wherein said abrasion process comprises grinding.

32. The method according to claim 30, further comprising polishing said glass disk medium substrate.

33. The method according to claim 26, further comprising annealing said glass disk medium substrate after said heating at temperature T₂.

34. The method according to claim 22, wherein said glass disk medium substrate formed has a diameter between about 70 mm and about 90 mm, a thickness between about 0.7 mm and about 0.9 mm, and a flutter of less than about 90 nm at 10,000 rpm.
